(19) United States
(12) Patent Application Publication
(10) Pub. No.: US 2012/0259673 A1
(43) Pub. Date: Oct. 11, 2012

(54) Risk-Based Complaint Management System

(75) Inventors: John A. Melquist, Skaneateles, NY (US); Carol A. Williams, Liverpool, NY (US); Pearley Bhambri, Camillus, NY (US); Brian R. Ray, Camillus, NY (US); Craig D. Mullin, Memphis, NY (US); Richard W. Thomas, Syracuse, NY (US)

(73) Assignee: WELCH ALLYN, INC., Skaneateles Falls, NY (US)

(21) Appl. No.: 13/082,486

(22) Filed: Apr. 8, 2011

(51) Int. Cl. G06Q 10/00

(52) U.S. Cl. 705/7.28

(57) ABSTRACT

A risk-based complaint management system is provided to effectively prioritize risks and streamline a complaint process. The risk-based complaint management system comprises a risk assessment database and a risk engine. The risk assessment database is provided to establish and maintain product-specific questions. The product-specific questions are associated to risk and severity levels of product risk assessment. The risk engine is configured to determine a risk level of a customer complaint based on responses to the product-specific questions with regards to the customer complaint.

### BACKGROUND

Most customer complaints are processed manually without a means of automated prioritization. Typically a call is received from the customer with an allegation in the form of a problem statement. The allegation is routed to address the problem and then closed. For a regulated business which is required to address all complaints in a uniform and timely manner, this is a very time and resource consuming activity. A means of determining whether an investigation is necessary or not is also required.

Although some complaints may have the same allegation or stated problem, most are handled in a serial manner or, as individual complaints. That means repeat complaints (same allegation or problem) follow the same process. This activity is required to ensure the complaint has been evaluated for safety hazards or regulatory requirements. There is no easy means of taking advantage of not having to re-address repeat problems for complaints that have already been addressed or investigated for the same problem.

### SUMMARY

In one aspect, a risk-based complaint management system comprises a risk assessment database. The risk assessment database is provided to establish and maintain product-specific questions. The product-specific questions are associated to risk and severity levels of product risk assessment. The risk-based complaint management system also comprises a risk engine. The risk engine is configured to determine a risk level of a customer complaint based on responses to the product-specific questions with regards to the customer complaint.

Another aspect is a method for managing a customer complaint. The method comprises receiving the customer complaint and presenting product-specific questions to the customer complaint. The product-specific questions are associated to risk and severity levels of product risk assessment. The method further comprises receiving responses to the product-specific questions, determining a risk level of the customer complaint based on the responses to the product-specific questions, and invoking a risk workflow based on the determination of the risk level.

Yet another aspect is a computing device for managing a customer complaint. The computing device comprises a processing unit and a memory that stores computer-executable instructions that, when executed by the processing unit, cause the computing device to receive the customer complaint, present product-specific questions to the customer complaint, the product-specific questions being associated to risk and severity levels of product risk assessment, receive responses to the product-specific questions, determine a risk level of the customer complaint based on the responses to the product-specific questions, invoke a risk workflow based on the determination of the risk level, the risk workflow including an auto-close process, and automatically close the customer complaint when the risk level is determined as low.

### BRIEF DESCRIPTION OF THE DRAWINGS

FIG. 1 is a block diagram illustrating an example risk-based complaint management system.

FIG. 2 is a flowchart illustrating an example logic and operation performed by a risk engine of the risk-based complaint management system.

FIG. 3 is an example risk table of the risk-based complaint management system.

FIG. 4 is an example user interface that a user captures and enters customer complaint information to the risk-based complaint management system.

FIG. 5 is a block diagram illustrating an example workflow of the risk-based complaint management system.

FIG. 6 is a block diagram illustrating an example computing system.

### DETAILED DESCRIPTION

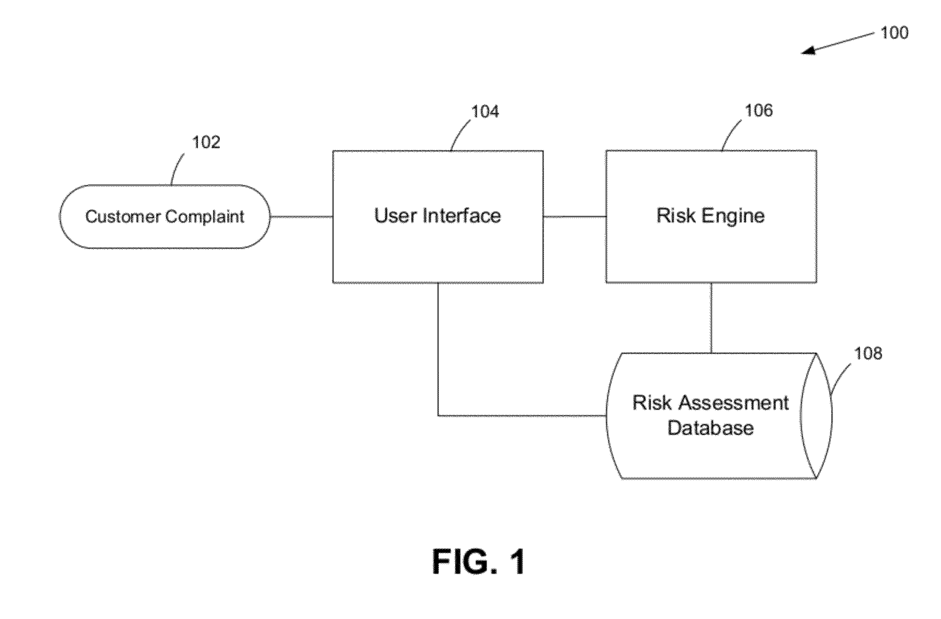

FIG. 1 is a block diagram illustrating an example risk-based complaint management system 100. The system 100 is configured to effectively prioritize risks and streamline a complaint process. As illustrated in the example of FIG. 1, the system 100 includes a user interface 104, a risk engine 106 and a risk assessment database 108.

A customer complaint 102 may be initiated by a phone call, fax, email, web-site, returned product, or other possible methods. The user interface 104 is configured to capture necessary inputs with regards to the customer complaint 102. When a user (e.g., a customer service representative) receives the customer complaint 102, the user may capture and enter customer complaint information to the system 100 through the user interface 104. The user interface 104 may present various product-specific questions and receive responses to the product-specific questions to capture and enter information of the customer complaint 102. In one embodiment, the user interface 104 is a web-based application user interface. For example, the user interface 104 may be implemented based on a programming model called Web Dynpro in a SAP system. Other embodiments and implementations are possible.

The risk assessment database 108 is built and maintained for processing by the risk engine 106. The system 100 uses the risk assessment database 108 to establish and maintain various data and information including the product-specific questions. The product-specific questions may include product, material and allegation set of questions. The risk assessment database 108 may include risk assessment matrix (tables) that define the customer complaint risk content and structure. The risk assessment tables correlate the product-specific questions to associated risk and severity levels. The product-specific questions are multi-level questions. When a response to a current level question is provided, the system 100 may present a next level question through the user interface 104. Each level question may have an associated risk and severity level.

The risk engine 106 is a computing and processing component of the system 100 that provides the logic for determining the risk level of the customer complaint 102. The risk level can be either high or low risk. The risk engine 106 determines the risk level of the customer complaint 102 based on responses to product-specific questions. For example, the risk engine 106 may determine the risk level of the customer complaint 102 based on the information gathered from the user interface 104 and the information provided from the risk assessment database 108.

Referring to FIG. 1, the initiation of the customer complaint 102 may begin with an allegation code being entered into the system 100. The allegation code may be selected from the user interface 104 when a level-1 question which is to ask for an allegation code is presented. This code and the product/material that is the subject of the customer complaint 102 are linked to a risk table that automatically assigns a level of risk based on the hazard(s) as defined in a product's risk assessment summary. The risk table may require that follow-up questions be asked of the complainant in order to distinguish between multiple hazards associated with the allegation code/product combination. The risk engine 106 associates the complaint allegation codes and questions to corresponding risk and severity levels. Risk tables are developed to correlate codes and questions to product risk assessment summaries. As a complaint is generated, the product that the allegation is made against is associated to a product risk table. The allegation code or a series of questions is run through logic steps resulting in either a high or low risk level for the customer complaint 102. The cascading level of questions is dependent on the allegation in the risk table.

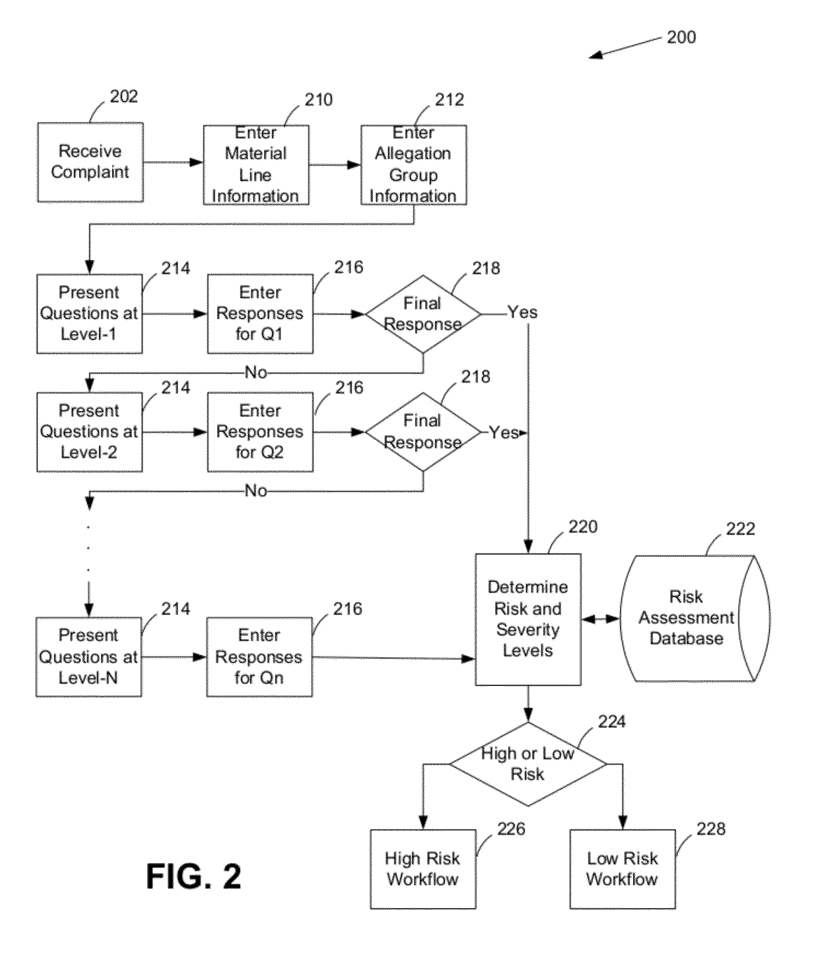

FIG. 2 is a flowchart illustrating an example logic and operation 200 performed by the risk engine 106 of the risk-based complaint management system 100 of FIG. 1. As illustrated in the example of FIG. 2, the operation 200 begins when the system 100 receives a customer complaint 202. In response to receiving the customer complaint 202, a user may directly enter the material/product line information 210. Next, the user enters allegation group information 212.

Next, the system 100 presents product-specific questions (e.g., a material/allegation set of questions) 214 from the risk assessment database 222 (108), based on the material line and allegation group entries. The user then selects appropriate response from the questions presented based on the response to a level-n response question by the user 216. In one embodiment, the level-1 question is to ask for an allegation code. The response for the allegation code may be selected from the user interface 104. If a response to a level-n response question is not provided to the user, then the material/allegation set of questions is concluded.

If a response to a level-n response question is provided to the user, the system displays the next level question (n+1). The cascading level of questions depends on the individual material/allegation set in the risk assessment matrix configuration. Each level-n response question has an associated severity level which is configured in the risk assessment database 222 (108) for each question.

Upon the final response 218 to the level-n response questions (level-1 through level-n), the risk engine 106 identifies the last severity value associated to the response(s) received. The risk engine 106 determines and establishes the complaint risk level (high or low) based on the combination of the information captured within this process 220. Upon completion of the risk engine processing, the system 100 updates and displays the complaint-specific risk level. Upon determination of the risk level from the operation 220, if the risk is a high risk, the high risk workflow 226 is invoked. If the risk is determined to be a low risk, the low risk workflow 228 is invoked. In one example, upon completion of the risk engine processing in operations 220, 224, the system 100 may also determine whether a potential death or injury is reported by the customer complaint 202. If a potential death or injury is reported to the user, the system 100 then sets the customer complaint 202 to be potentially reportable high risk. If a pre-defined “key word” (e.g., neonatal, infant, airplane etc.) is selected by the user to a product, the system 100 sets the customer complaint 202 to be potentially reportable high risk. If a business risk is indicated by the customer complaint 202, the user may select the business risk from a drop-down list in the user interface 104, and then continue the complaint recording process.

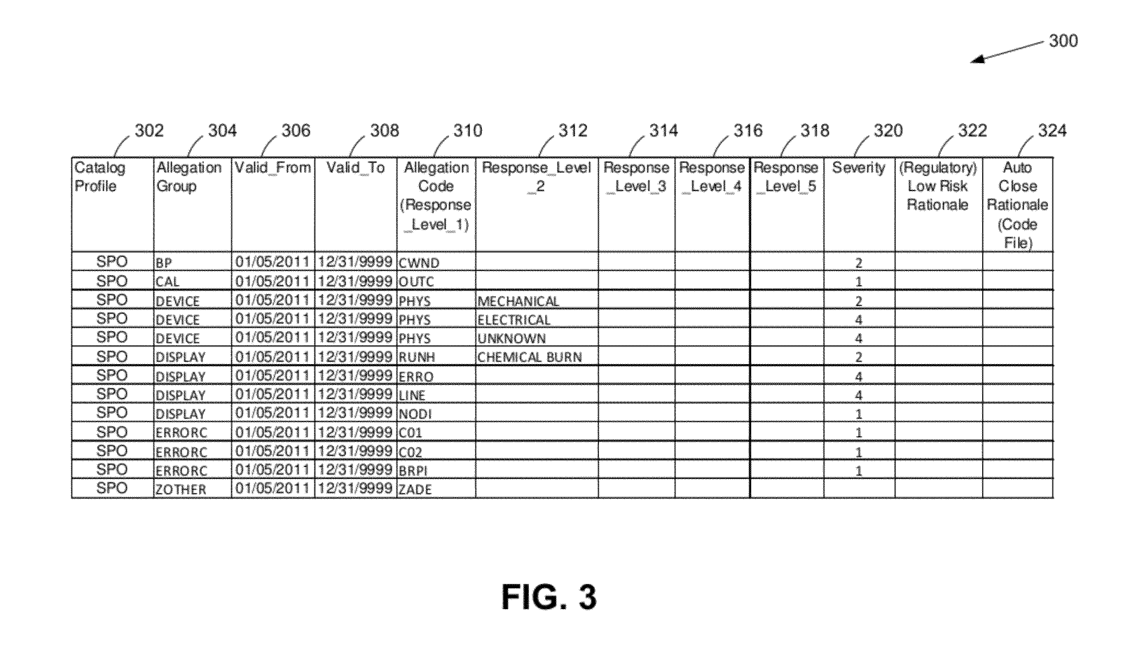

FIG. 3 is an example risk table 300 of the risk assessment database 108 in FIG. 1. The risk table 300 correlates product-specific questions to associated risk and severity levels. In the example table 300, column 302 indicates the catalog profile. Column 304 indicates the allegation group. Columns 306, 308 include the date validity information for this set of risk table 300. Question bank can be maintained with validity dates from current date into future. Each record loaded will be valid from the valid from date (as defined in the file) to Dec. 31, 9999. Any new record added should have a starting date and program will add a new record starting from the new “valid from date” to Dec. 31, 9999.

There are 5 levels of questions illustrated in this example. Level 1 question 310 is regarding an allegation code. Level-2 through level-5 312, 314, 316, 318 are the subsequent questions to get more information. There may be more branches to the questions and responses at level-2 through level-5, depending on the complexity of the risk assessment database for the particular material and allegation combination. Each level of question will point to severity 320 of the complaint. A regulatory low risk rationale column 322 holds the regulatory rationale document number which justifies changing a high risk to a low risk. An auto close rationale column 324 holds number of a document which justifies auto closure of a low risk complaint. A high risk complaint with a regulatory low risk rationale has an auto-close rationale present on the risk assessment matrix table 300 in order to consider this complaint for an auto-close. If a customer complaint is determined to be a high risk based on either a potential death or injury, or a pre-defined key word is reported in the customer complaint, then the regulatory low risk rational does not override the high risk determination.

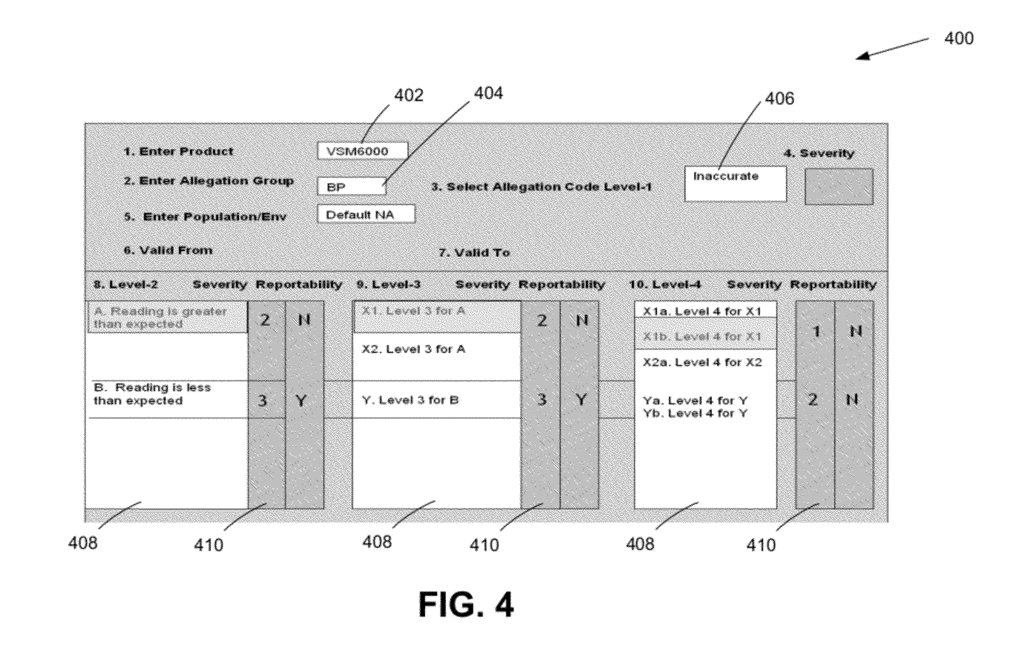

FIG. 4 is an example user interface 400 (104) that a user captures and enters customer complaint information to the system 100. The user may enter to the system the product and allegation code information of the customer complaint 102. Once the necessary product and allegation code information about the customer complaint 102 is captured and entered, the user interface 104 may present various more product-specific questions and receive responses to the product-specific questions regarding the customer complaint 102. As illustrated in the example, a user may enter product category information in data field 402. Allegation group information can be entered in data field 404. Preferably in another embodiment, the allegation group information is automatically displayed in data field 404 when the corresponding product category information is entered in data field 402. The user may select an allegation code in the level-1 question 406. Questions and responses 408 at level 2 through level 4 are presented and can be answered and selected accordingly. Each level of question will point to severity 410.

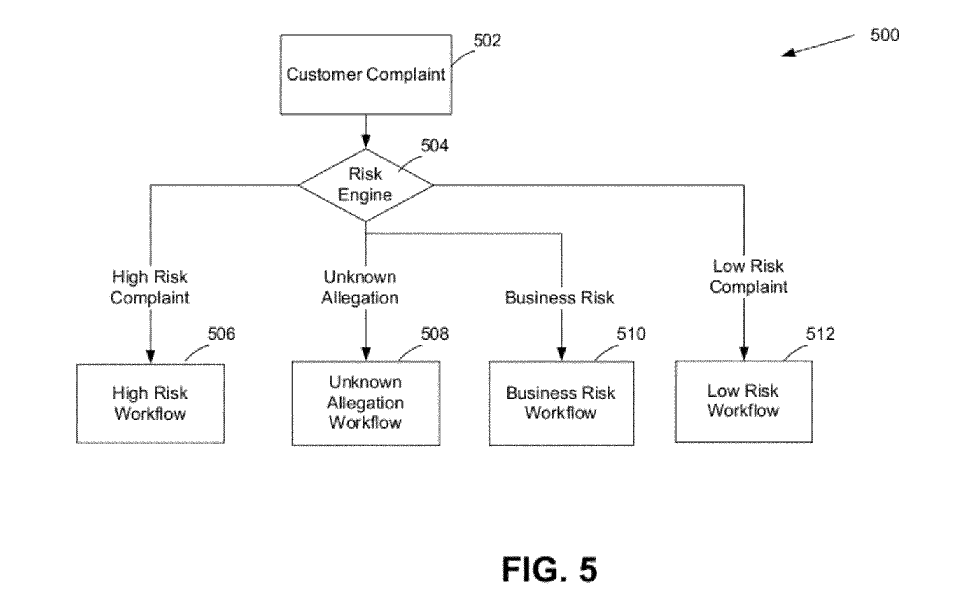

FIG. 5 is a block diagram illustrating an example workflow 500 of the risk-based complaint management system 100. The risk-based complaint management system 100 is comprised of a set of integrated workflows. These workflows are designed to integrate and facilitate the efficient processing of product-based customer complaints. The individual workflows control the different aspects of the complaint process.

Referring to FIG. 5, when a customer complaint 502 is received by the system 100, the risk engine 504 (106) determines the risk level and severity of the customer complaint 502. If death or injury information is reported from the customer complaint 502, the risk engine then determines the customer complaint 502 as a potentially reportable high risk. Also, if a pre-defined key word (e.g., neonatal, infant, airplane) is associated to the customer complaint 502, the risk engine determines the customer complaint 502 as a potentially reportable high risk.

In addition, if the user responses to the material/allegation level-n response questions correspond to high severity levels within the risk assessment matrix, the risk engine determines the customer complaint 502 as a safety high risk.

If the customer complaint 502 is determined as a high risk, the flow goes to the high risk workflow 506. If the high risk complaint is determined not to be reportable by the user, then the system 100 follows a low risk workflow 512 to an auto-close and/or product retrieval and service findings workflows (not shown), based on product retrieval requirements and status.

If the high risk complaint is determined (by the user) to require regulatory reporting, a reportable complaint sub-workflow (not shown) follows and tracks various required reporting, investigation and closing processes.

The risk engine 504 (106) determines the customer complaint 502 as an unknown allegation code high risk when: (a) a company product is identified in the complaint entry; (b) information regarding the customer complaint 502 is provided by the customer contact; and (c) a matching allegation code could not be determined based on the customer complaint information. For example, a matching allegation code could not be determined when the allegation group or material/allegation code is not populated in the risk assessment matrix (database) 108, or when the customer complaint 502 does not match the available allegation group or material/allegation code.

If the customer complaint is determined as an unknown allegation code high risk, the flow goes to the unknown allegation workflow 508. The unknown allegation workflow 508 provides a controlled mechanism to process complaints for new or previously unknown product-related allegations and triggers the tasks to identify the risk assessment matrix maintenance requirements.

The risk engine 504 determines the customer complaint 502 has a business risk when a business risk selection list entry is selected for a customer complaint in the system 100. A business risk is not a separate complaint. It is an addendum to a customer complaint for issues that are not directly product related. All of the customer complaint types (high risk, low risk, and a third-party product) can have an associated business risk. The business risk workflow 510 allows for the parallel processing of the product safety aspects of a complaint in tandem with the businesses or non-product safety conditions, reported by the customer. For example, the system 100 may show a pop up with option to record details in a long text reserved for the business risk. The system 100 may auto-generate a line entry to a business risk report table that identifies the complaint, customer, business risk, date of creation, region. The system 100 may not create any task in the complaint. The system 100 stores details pertaining to the business risk in custom table which will be used for a work list. An identified business risk resource will use the work list to track the business risks. For example, the identified business risk resource can use a work list report to review business risks assigned to customer complaints by the status of the business risk, date range and person assigned to work on the business risk. The identified business risk resource has the ability to close the business risk by manually entering the close date and the reason for closure into the business risk report table. The identified business risk resource may also report and trend business risk details, such as—by type (from business risk selection list), open business risks, and reasons of closure.

As for the determination of a low risk complaint, if the responses to the material/allegation level-n response questions correspond to a high severity level within the risk assessment matrix, the risk engine 504 (106) determines the complaint as a low risk complaint with rationale when: (a) a death or injury selection is not selected, b) no pre-defined key word (e.g., neonatal, infant, airplane) is selected, c) both the allegation group or allegation code are known, and d) a documented rationale for a low risk complaint is referenced in the risk assessment matrix.

If the responses to the material/allegation level-n response questions correspond to a low severity level within the risk assessment matrix, the risk engine 504 (106) determines the complaint as a low risk complaint when: (a) death/injury selection is not selected, b) no pre-defined key word (e.g., neonatal, infant, airplane) is selected, and c) both the allegation group or allegation code are known.

If the risk engine 504 (106) determines complaint risk as a low risk, a low risk complaint workflow 512 is invoked for the processing of the low risk complaint. The low risk workflow 512 is provided to quickly identify and process complaints and to drive the low risk complaint to an auto-close process. The auto-close process verifies that all complaint tasks have been completed and that there is pre-defined allegation code documentation to justify and support the auto-closing of a customer complaint.

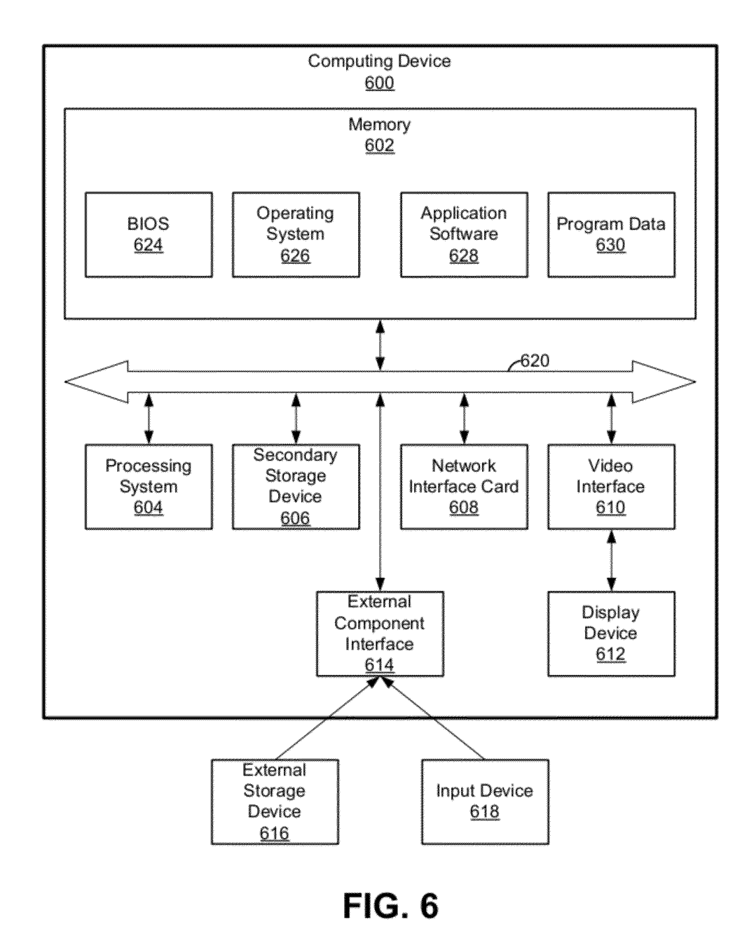

FIG. 6 is a block diagram illustrating an example computing device 600. In some embodiments, the risk-based complaint management system 100 comprises one or more computing devices like the computing device 600. It should be appreciated that in other embodiments, the risk-based complaint management system 100 is provided by computing devices having hardware components other than those illustrated in the example of FIG. 6.

In different embodiments, computing devices are implemented in different ways. In the example of FIG. 6, the computing device 600 comprises a memory 602, a processing system 604, a secondary storage device 606, a network interface card 608, a video interface 610, a display device 612, an external component interface 614, an external storage device 616, an input device 618, and a communication medium 620. In other embodiments, computing devices are implemented using more or fewer hardware components. For instance, in another example embodiment, a computing device does not include a video interface, a display device, an external storage device, or an input device.

The term computer-readable media as used herein may include computer-readable storage media. Computer-readable storage media include devices or articles of manufacture that store data and/or computer-executable instructions readable by a computing device. Computer-readable storage media can be volatile or nonvolatile and can be removable or non-removable. Computer-readable storage media can store various types of information, including computer-executable instructions, data structures, program modules, or other data. Example types of computer-readable storage media include, but are not limited to, dynamic random access memory (DRAM), double data rate synchronous dynamic random access memory (DDR SDRAM), reduced latency DRAM, DDR2 SDRAM, DDR3 SDRAM, solid state memory, flash memory, read-only memory (ROM), electrically-erasable programmable ROM, magnetic disks, magnetic tape drives, CD-ROM discs, DVD-ROM discs, Blu-Ray discs, Bernoulli cartridges, and other types of devices and/or articles of manufacture that store data.

The memory 602 includes one or more computer-readable storage media capable of storing data and/or computer-executable instructions. In different embodiments, the memory 602 is implemented in different ways. For instance, in various embodiments, the memory 602 is implemented using various types of computer-readable storage media.

The term computer-readable media as may also include communication media. Computer readable instructions, data structures, program modules, or other data in a modulated data signal, such as a carrier wave or other transport mechanism, may be embodied in a communication medium. The term “modulated data signal” may describe a signal that has one or more characteristics set or changed in such a manner as to encode information in the signal. For example, communication media can include wired media such as a wired network or direct-wired connection, and wireless media such as acoustic, radio frequency (RF), infrared, and other wireless media.

The processing system 604 includes one or more processing units. A processing unit is an integrated circuit that selectively executes computer-executable instructions. In various embodiments, the processing system 604 is implemented in various ways. For example, the processing system 604 can comprise one or more processing cores. In another example, the processing system 604 can comprise one or more separate microprocessors. In yet another example, the processing system 604 can comprise one or more ASICs that provide specific functionality. In yet another example, the processing system 604 can provide specific functionality by using an ASIC and by executing software instructions.

The secondary storage device 606 includes one or more computer-readable storage media. The secondary storage device 606 stores data and software instructions not directly accessible by the processing system 604. In other words, the processing system 604 performs an I/O operation to retrieve data and/or software instructions from the secondary storage device 606. In various embodiments, the secondary storage device 606 is implemented by various types of computer-readable storage media.

The network interface card 608 enables the computing device 600 to send data to and receive data from a communications medium, such as a computer communication network. In different embodiments, the network interface card 608 is implemented in different ways. For example, the network interface card 608 can be implemented as an Ethernet interface, a fiber optic network interface, a wireless network interface (e.g., WiFi, 3G, 4G, WiMax, etc.), a modem, or another type of network interface.

The video interface 610 enables the computing device 600 to output video information to the display device 612. In different embodiments, the video interface 610 is implemented in different ways. For instance, in one example embodiment, the video interface 610 is integrated into a motherboard of the computing device 600. In another example embodiment, the video interface 610 is a video expansion card.

In various embodiments, the display device 612 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 610 communicates with the display device 612 in various ways. For instance, in various embodiments, the video interface 610 communicates with the display device 612 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 614 enables the computing device 600 to communicate with external devices. In various embodiments, the external component interface 614 is implemented in different ways. For instance, in one example embodiment, the external component interface 614 is a USB interface. In other example embodiments, the computing device 600 is a FireWire interface, a serial port interface, a parallel port interface, a PS/2 interface, and/or another type of interface that enables the computing device 600 to communicate with external components.

The external storage device 616 is an external component comprising one or more computer readable data storage media. Different implementations of the computing device 600 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 618 is an external component that provides user input to the computing device 600. Different implementations of the computing device 600 interface with different types of input devices. Example types of input devices include, but are not limited to, keyboards, mice, trackballs, stylus input devices, key pads, microphones, joysticks, touch-sensitive display screens, and other types of devices that provide user input to the computing device 600.

The communications medium 620 facilitates communication among the hardware components of the computing device 600. In different embodiments, the communications medium 620 facilitates communication among different components of the computing device 600. For instance, in the example of FIG. 6, the communications medium 620 facilitates communication among the memory 602, the processing system 604, the secondary storage device 606, the network interface card 608, the video interface 610, and the external component interface 614. In different implementations of the computing device 600, the communications medium 620 is implemented in different ways. For instance, in different implementations of the computing device 600, the communications medium 620 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 602 stores various types of data and/or software instructions. For instance, in the example of FIG. 6, the memory 602 stores a Basic Input/Output System (BIOS) 624, an operating system 626, application software 628, and program data 630. The BIOS 624 includes a set of computer-executable instructions that, when executed by the processing system 604, cause the computing device 600 to boot up. The operating system 626 includes a set of software instructions that, when executed by the processing system 604, cause the computing device 600 to provide an operating system that coordinates the activities and sharing of resources of the computing device 600. Example types of operating systems include, but are not limited to, MICROSOFT® WINDOWS®, Linux, Unix, Apple OS X, Apple iOS, Google Chrome OS, Google Android OS, and so on. The application software 628 includes a set of software instructions that, when executed by the processing system 604, cause the computing device 600 to provide applications. The program data 630 is data generated and/or used by the application software 628.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

What is claimed is:

1. A risk-based complaint management system, the system comprising:
a risk assessment database provided to establish and maintain product-specific questions, the product-specific questions being associated to risk and severity levels of product risk assessment; and
a risk engine configured to determine a risk level of a customer complaint based on responses to the product-specific questions with regards to the customer complaint.

2. The system of claim 1, wherein the product-specific questions are multi-level questions, wherein a first level question is an allegation code question to inquiry an allegation code associated with the customer complaint, wherein the system presents a next level question when a response to a current level question is provided, each level question having an associated risk and severity level.

3. The system of claim 1, further comprising:
a user interface provided to capture inputs with regards to the customer complaint, present the product-specific questions, and receive the responses to the product-specific questions.

4. The system of claim 1, wherein the risk assessment database includes one or more risk tables correlating the product-specific questions to associated risk and severity levels.

5. The system of claim 1, wherein the system segregates and classifies customer complaints into either a high or low risk level.

6. The system of claim 5, wherein the risk level is represented with a numeric risk severity number, a numeric risk severity of 2 or less representing low risk while 3 or greater represents high risk.

7. The system of claim 1, wherein, upon determination of the risk level, if the risk is a high risk, a high risk workflow is invoked

8. The system of claim 1, wherein, upon determination of the risk level, if the risk is a low risk, a low risk workflow is invoked.

9. The system of claim 1, wherein the customer complaint includes an associated business risk, the associated business risk being an addendum to the customer complaint for issues that are not directly product related.

10. A method for managing a customer complaint, the method comprising:
receiving the customer complaint;
presenting product-specific questions to the customer complaint, the product-specific questions being associated to risk and severity levels of product risk assessment;
receiving responses to the product-specific questions;
determining a risk level of the customer complaint based on the responses to the product- specific questions; and
invoking a risk workflow based on the determination of the risk level.

11. The method of claim 10, wherein the product-specific questions are multi-level questions, wherein presenting the product-specific questions includes presenting a first level question which is an allegation code question to inquiry an allegation code associated with the customer complaint, wherein presenting the product-specific questions includes presenting a next level question when a response to a current level question is provided, each level question having an associated risk and severity level.

12. The method of claim 10, further comprising:
invoking a high risk workflow if the risk level of the customer complaint is determined as high.

13. The method of claim 10, further comprising:
invoking a low risk workflow if the risk level of the customer complaint is determined as low.

14. The method of claim 13, wherein the risk workflow includes an auto-close process.

15. The method of claim 10, further comprising automatically closing the customer complaint when the risk level is determined as low.

16. The method of claim 10, further comprising:
setting the customer complaint to be potentially reportable if death or injury information is reported from the customer complaint.

17. The method of claim 10, further comprising:
setting the customer complaint to be potentially reportable if a pre-defined key word is reported from the customer complaint.

18. The method of claim 10, further comprising correlating the product-specific questions to associated risk and severity levels through a risk table.

19. A computing device for managing a customer complaint, the computing device comprising:
a processing unit; and
a memory that stores computer-executable instructions that, when executed by the processing unit, cause the computing device to:
receive the customer complaint;
present product-specific questions to the customer complaint, the product-specific questions being associated to risk and severity levels of product risk assessment;
receive responses to the product-specific questions;
determine a risk level of the customer complaint based on the responses to the product-specific questions;
invoke a risk workflow based on the determination of the risk level, the risk workflow including an auto-close process; and
automatically close the customer complaint when the risk level is determined as low.

20. The computing device of claim 19, wherein the product-specific questions are multi-level questions, wherein presenting the product-specific questions includes presenting a first level question which is an allegation code question to inquiry an allegation code associated with the customer complaint, wherein presenting the product-specific questions includes presenting a next level question when a response to a current level question is provided, each level question having an associated risk and severity level.
